(19) United States
(12) Patent Application Publication
(10) Pub. No.: US 2004/0230898 A1
(43) Pub. Date: Nov. 18, 2004

(54) Identifying topics in structured documents for machine translation

(75) Inventors: Jason Y. Blakely, Cary, NC (US); Robert S. Sielken, Chapel Hill, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/436,898

(22) Filed: May 13, 2003

(51) Int. Cl. G06F 15/00

(52) U.S. Cl. 715/513; 715/514

(57) ABSTRACT

Techniques are disclosed for identifying the topic or subject area of content within a structured document, thereby facilitating a machine translation of the content within an appropriate context. Several alternative syntax approaches are described, using new tags, new attributes on existing tags, and existing tags and attributes having new values. Programmatically informing a translation engine of the subject area of content to be translated (i.e., by embedding this information in the content, as disclosed herein) allows many terms to be disambiguated. As a result, the translation engine can translate content more accurately and more efficiently.

### BACKGROUND OF THE INVENTION

1. Field of the Invention

The present invention relates to a computer system, and deals more particularly with techniques for identifying the topic(s) or subject areas) of content within a structured document, thereby facilitating a machine translation of the content within an appropriate context.

2. Description of the Related Art

Companies have long re cognized the desirability of providing text translation for computer software products. Users can then interact with the software product in their own preferred language, rather than requiring them to adapt to the language (such as English) used by the product's developers. For example, if a software product displays menus to users, it is preferable to provide menu text that is translated into the particular language preferred by the user. Similarly, software products that generate text messages for recording in an error log preferably provide message text that will be recorded in the user's preferred language.

Early text translation efforts were focused on identifying and externalizing the text strings produced by a software product. That is, in order to translate the text strings into multiple languages efficiently, it was recognized that those strings should be not embedded inline within the code of the software product. Instead, tables (such as message tables) were defined to store the strings, and software products were written to use mnemonics or numeric identifiers which then could be used to index into the tables. Having the text strings externalized in this manner made translation easier, as a translator could simply substitute an appropriate version of each string in place within the table (or provide replacement tables in different languages), and the software would then access the translated text using the original mnemonic or numeric identifier.

Many of today's software products are written to produce and consume information that is represented using structured documents encoded in markup languages. Use of structured documents has also become increasingly prevalent in recent years as a means for exchanging information between computers in distributed networking environments. The Hypertext Markup Language, or “HTML”, as one example, is a markup language that is widely used for encoding the content of structured documents that represent Web pages. The Web page content can be transmitted between computers of the public Internet for rendering to users, and may also be used for other purposes (and in other environments such as private intranets and extranets). The Extensible Markup Language, or “XML”, is another markup language that has proven to be extremely popular for encoding structured documents. XML is very well suited for encoding document content covering a broad spectrum, not only for transmission between computers but also, in some cases, to enable automated processing of document content. XML has also been used as a foundation for many other derivative markup languages that are adapted for specialized use, such as VoiceXML, MathML, and so forth.

Machine translation techniques, also referred to as automated translation techniques, are known in the art and machine translators are commercially available. Given a term or phrase in one language, a machine translator performs a programmatic conversion and returns the translated version thereof in a target language. The task of machine translation is quite difficult, and existing machine translators often suffer from poor-quality translations, due to content ambiguity. For example, suppose a paragraph of text from a Web page that is to be rendered on the Internet site of a news service contains the word “strike”. This is an ambiguous word that has different meanings in different contexts. If the paragraph is discussing bowling, then “strike” may mean that a bowler knocked down ten pins with one roll of the bowling ball. If the paragraph is discussing baseball, then “strike” may mean that a batter attempted to hit the baseball, but missed. Or, “strike” might be used in a labor relations context, referring to a labor dispute among the baseball players or umpires. As illustrated by this simple example, choosing the correct context for terms to be translated is key to producing a meaningful result.

In view of the vast amount of content being encoded in structured documents today, and the increasing tendency to distribute such content throughout the world over distributed computing networks, techniques are needed for efficiently and reliably translating content encoded in structured documents.

### SUMMARY OF THE INVENTION

An object of the present invention is to provide efficient and reliable techniques for translating content encoded in structured documents.

Another object of the present invention is to provide techniques for efficiently and reliably translating textual information in structured documents into different languages.

It is another object of the present invention to provide techniques that enable programmatically disambiguating content to be translated.

Still another object of the present invention to provide techniques for identifying topics or subject areas within structured document content.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides methods, systems, and computer program products for improving machine translation by identifying topics in structured documents. In preferred embodiments, this preferably comprises: identifying one or more topics of content in a structured document; and adding markup language syntax to the structured document, for each one of the identified topics, to specify each of the identified topics, wherein the added markup language syntax is usable by a machine translator to programmatically determine a context for use when programmatically translating the content.

In one aspect, the added markup language syntax comprises a markup language tag that precedes content of each one of the identified topics. Each of the markup language tags may specify one of the identified topics as an attribute; or, each of the markup language tags may specify one of the identified topics as a tag value.

The markup language tags may be, for example, XML or HTML tags. For XML tags, each tag preferably has a corresponding closing tag that follows the content of the identified topic. The HTML tags may be META tags, or tags that are specifically defined for content topic identification.

In another aspect, the added markup language syntax comprises a markup language tag attribute that is specified on a markup language tag that precedes the content on each of the topics. A value of the markup language tag attribute may specify the identified topic. The markup language tag attributes may be, by way of example, attributes of XML tags or HTML tags.

The machine translator may then use the added markup language syntax to programmatically determine the context of the content when it programmatically translates the content. The content to be translated by the machine translator may be textual content.

The present invention may also be used advantageously in methods of doing business. For example, techniques disclosed herein may be used by companies providing content translation services. These translation services may include adding topic identifications to structured documents, of the form disclosed herein, and/or performing machine translation of structured documents containing these topic identifications. When provided for a fee, these translation services may be provided under various revenue models, such as pay-per-use billing, a subscription service, monthly or other periodic billing, and so forth.

The present invention will now be described with reference to the following drawings, in which like reference numbers denote the same element throughout.

### BRIEF DESCRIPTION OF THE DRAWINGS

FIG. 1 provides a small sample of textual content, and is used in illustrating limitations of the prior art;

FIGS. 2, 3, 7-9, 12, and 13 illustrate alternative techniques that may be used for indicating subject areas in structured documents, according to embodiments of the present invention;

FIG. 4 provides another sample document for purposes of illustrating limitations of the prior art;

FIGS. 5, 6, 10, 11, and 14 show how techniques disclosed herein may be used to embed subject area information in structured document content, according to preferred embodiments;

FIG. 15 provides a flowchart depicting logic that may be used to implement embodiments of the present invention;

FIG. 16 is a block diagram of a computer hardware environment in which the present invention may be practiced; and

FIG. 17 is a diagram of a networked computing environment in which the present invention may be practiced.

### DESCRIPTION OF PREFERRED EMBODIMENTS

Practitioners of the art who enable their structured documents for translation into different languages understand that existing prior art techniques are difficult and error-prone. Typically, prior art content translation processes comprise writing a document in a specific language, normally English, and then handing the document to a translation team. The translators then produce documents in other languages by copying the original to create a new document wherein each element identified by the translation team as translatable has been manually replaced with the appropriate translated element. This process can also be very time-consuming and tedious.

Machine translation techniques of the prior art are typically less time-consuming and tedious than this type of manual translation. However, the machine translations tend to be more error-prone than translations performed by humans, who can intuitively discern the context of the document and disambiguate any ambiguous terms.

Machine translation may be improved by associating a topic (referred to equivalently herein as a subject area) with a document or content that is to be translated. For example, if a topic of “sports” is associated with an HTML or XML document (or an area of text within such a document), then it may be possible to disambiguate an ambiguous phrase or word like “strike”, which has one meaning in labor relations, another in baseball, and yet another in bowling. As a result of the disambiguation, the phrase or word can then be translated correctly. Note that while associating a subject area of “sports” with a document could exclude the labor relations definition, there could still be confusion between the baseball and bowling terms. So, the subject area of sports might need to be further refined to, for example, “team sports”, which suggests that the baseball term is the correct choice.

Subject area nomenclature is arbitrary, and therefore the domain can get quite large. In one prior art approach, current machine translation techniques specify a subject area for translation in the API (application programming interface) call to the translation engine. For example, when invoking the Begin Translation logic of the IBM® WebSphere® Translation Server, the following API call syntax specifies that HTML format is to be used and that the context of the content to be translated is sports and/or business:

ItBeginTranslation(“*format=html *subject=sports, business”); (“WebSphere” and “IBM” are registered trademarks of International Business Machines Corporation.)

However, two problems exist when using this prior art approach. First, this approach requires knowing which of the numerous subject areas to utilize over the set of documents to be translated. Frequently, the person administering the translation API (that is, coding the API invocations that will perform the translation) is not the creator of the documents, and thus has no knowledge of which subject areas should be utilized. (This knowledge is available to the document creator when the document is created, and can be recorded using techniques disclosed herein.)

The second problem with the prior art approach is that the API requires specification of the subject areas for the entire collection of documents that are to be translated. The candidate documents may span a wide variety of unrelated topics, each needing its own distinct subject area. For example, a major news Web site might have dozens of stories each day. To send the HTML content for such a Web site to a machine translator, and in particular to use a translation API such as that shown above, the subject area for each story should be specified. However, by specifying the entire collection of subject areas for a set of documents (i.e., the union of the subject areas of all of the documents), it is likely that a large number of subject areas may be in use at one time, which may even worsen the machine translator's ability to disambiguate terms in the content. With so many subject areas to choose from, the machine translator may mistakenly use a subject area that does not really apply to a particular document (e.g., when only one of the set of subject areas was actually pertinent to this particular document).

The present invention embeds a tag within a structured document, solving the problems just described. By having the content creator include this tag, the person administering the translation API no longer has to guess what the topic of the content should be. Instead, the person who is most familiar with the content—its creator—simply records the subject area within the document, using a subject area tag that will then automatically be stored and transmitted with the document. In addition, each translation request no longer needs to specify the subject area when using an embedded tag as disclosed herein: the subject area can be programmatically determined by locating the embedded tag. When requesting translation of content that spans multiple subject areas, the problem of having inapplicable subject areas applied, with an adverse affect on translation quality, is also avoided using techniques disclosed herein. Instead, a translation engine processing content that has an embedded subject area tag simply reads the tag and adjusts the translation accordingly, on a document-by-document basis. Support may also be provided for embedding multiple subject area tags within a document, as will be described in more detail below, and thus the translation may even be adjusted on a document section-by-document section basis.

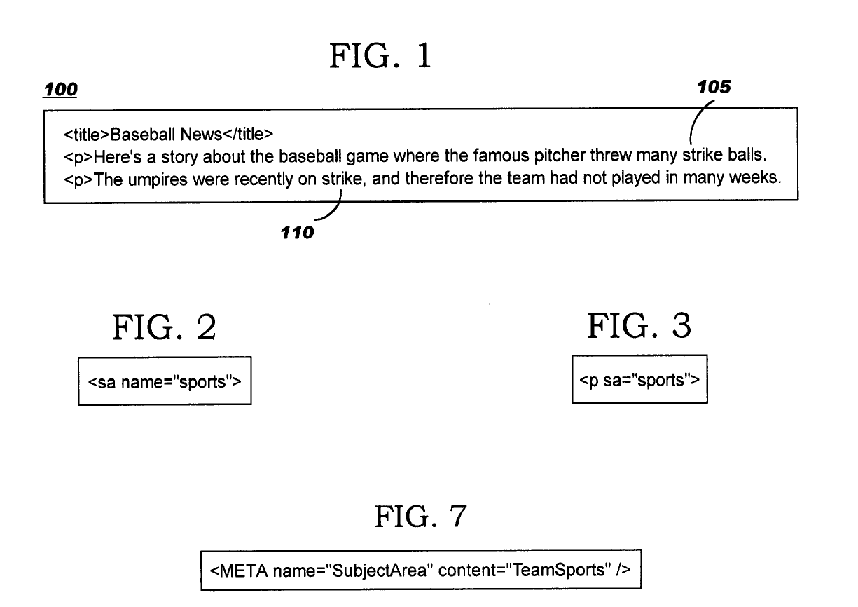

FIG. 1 provides a small sample of textual content 100 discussing baseball. As discussed earlier, the word “strike” may have many different meanings in different contexts, and this is illustrated by two uses of “strike” in the sample textual content. See reference numbers 105, 110. In this example, the first usage at 105 may be translated properly if it is known that the topic of the story is “sports”. However, the second usage at 110 has a labor relations context. Therefore, multiple tags are preferably embedded in this type of content to guide the machine translator in performing an accurate translation. (As stated above, the content creator is preferably responsible for including the subject area tags, and is in an optimal position to determine whether a single subject area or multiple subject areas should be specified for an individual document.)

Embodiments are disclosed herein for use with HTML and with extensible notations such as XML. Currently, there are no HTML tags for handling subject areas. Therefore, support for the present invention in HTML documents is facilitated by introducing a new tag or by expanding an existing tag to introduce new attributes.

FIG. 2 illustrates an example of a new tag, “<sa>” (for “subject area”), that may be defined for use in HTML documents. As shown therein, this tag preferably includes an attribute such as “name”, the value of which identifies the subject area of the following content. FIG. 3 provides an example showing how an existing tag may be extended with new attributes. Here, the HTML paragraph tag, “<p>”, has a subject area (“sa”) attribute, thereby providing paragraph-level control over the context used by the translation engine. Each of these techniques may be supported in separate embodiments of the present invention, or an embodiment may support a new HTML tag as well as extensions to existing tags.

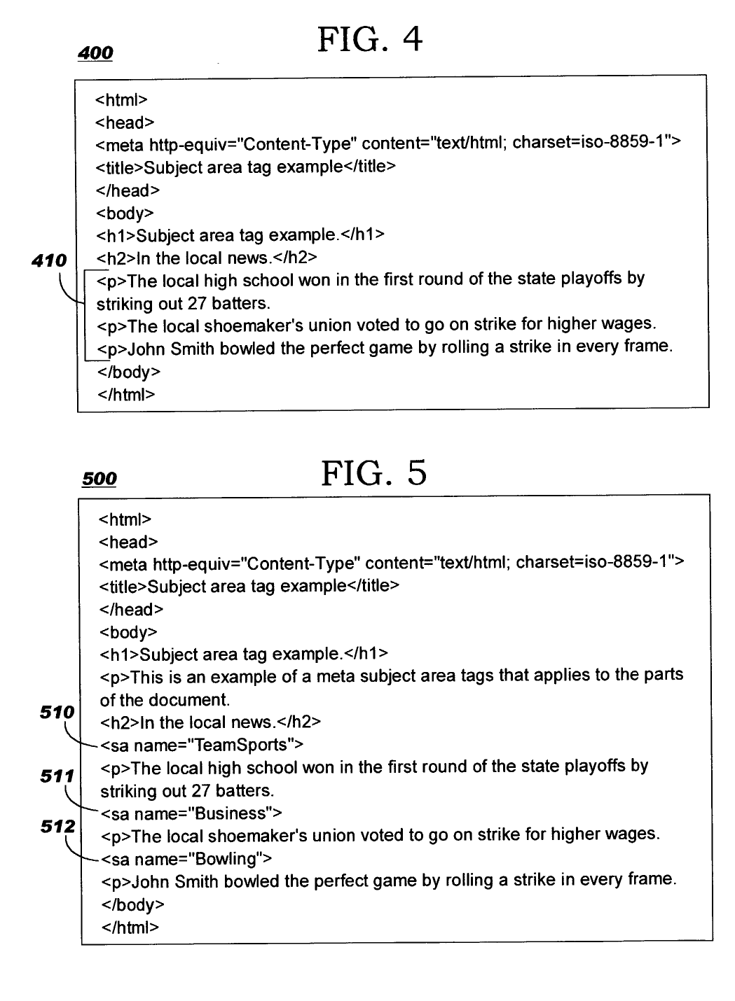

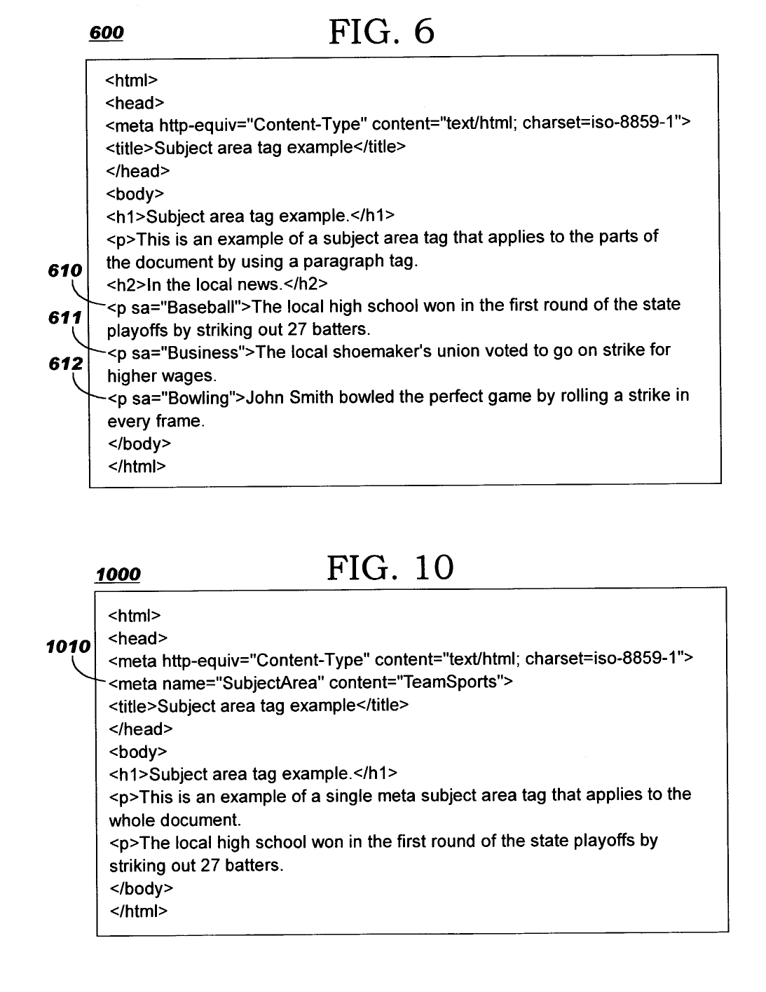

FIG. 4 shows a sample HTML document 400 of the prior art, containing several sentences that might describe the day's headlines. As can be seen by inspection, each of the three paragraphs at 410 uses a different context for strikes. FIGS. 5 and 6 show the same HTML document, after tags have been embedded using the approach shown in FIGS. 2 and 3, respectively. In document 500, an <sa> tag is specified for each of these paragraphs, as shown at 510, 511, 512. Document 600 uses an “sa” attribute on the paragraph tag for each of the paragraphs, as shown at 610, 611, 612. Programmatically informing the translation engine that the subject areas for these paragraphs are “Baseball” or “TeamSports”, “Business”, and “Bowling”, respectively, will allow the translation to be more accurate (and, typically, to proceed more quickly) than when using prior art machine translation techniques.

In yet another approach, no new HTML tags or tag attributes are required. This approach has the advantage of compatibility with existing HTML processors such as browsers. An existing HTML tag that may be leveraged is the META tag. The META tag is known in the art, and may be used to identify properties of a document (although use of this tag for specifying subject areas is not known). A META tag with a “name” attribute is illustrated in FIG. 7. The “name” attribute on a META tag identifies a property name, and a corresponding “content” attribute then specifies a value for that named property. Thus, the example in FIG. 7 indicates that the named property “SubjectArea” is assigned the value “TeamSports”. (For more information on use of the META tag, refer to “Hypertext Markup Language 4.0 Specification”, April 1998, which is available from the World Wide Web Consortium or “W3C”.)

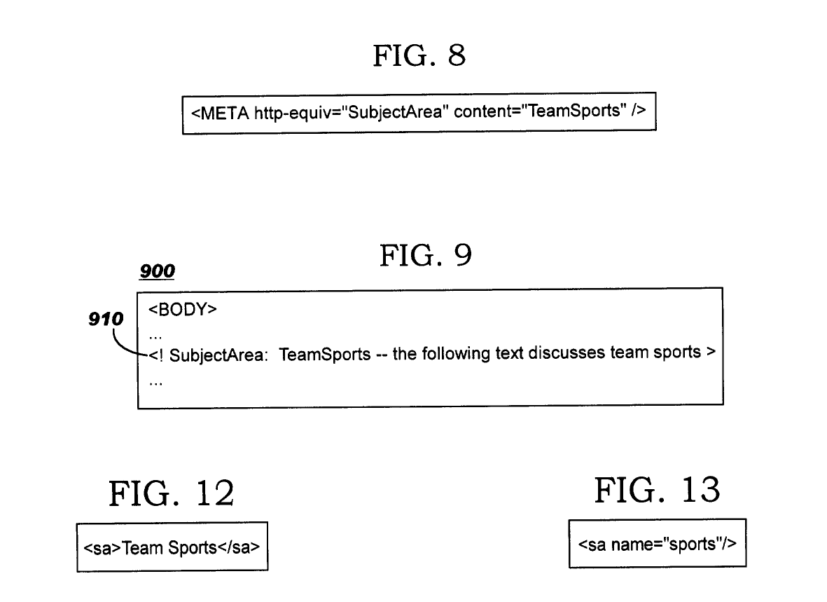

In an alternative form, an “http-equiv” attribute may be used on a META tag in place of the “name” attribute. The “http-equiv” attribute is intended to be used in markup language documents to explicitly specify information equivalent to that which a Hypertext Transfer Protocol (“HTTP”) server should gather and then convey in the HTTP response message with which the document is transmitted. However, this syntax may be overloaded for purposes of the present invention to specify subject area information. This alternative form is illustrated in FIG. 8, which provides the same subject area information as FIG. 7.

In yet another alternative form, subject area information may be specified within HTML documents using specially-denoted comments. This is illustrated at element 910 of the sample document 900 in FIG. 9. As shown therein, this example uses a keyword “SubjectArea” following by a colon, followed by a textual value of “TeamSports”. Optionally, a more detailed description may then be provided. In the example in FIG. 9, this detailed description follows the syntax “--”.

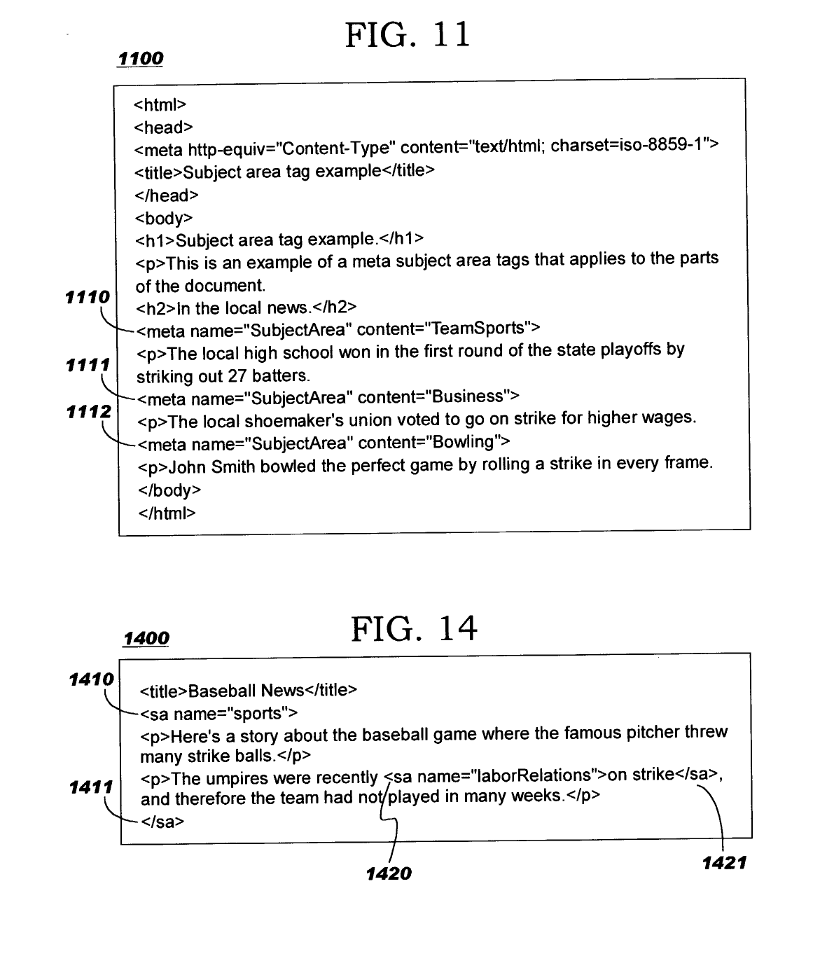

FIGS. 10 and 11 illustrate use of the META tag with the “name” attribute in a structured document, showing how this tag may be used to specify a document-wide subject area (in FIG. 10) or subject areas that change within a document (in FIG. 11). The example document 1000 of FIG. 10 shows a single META tag, at 1010, identifying the subject area of this document as “TeamSports”. Document 1100 of FIG. 11 uses a META tag with a “name” attribute preceding each of three paragraph tags, as shown at 1110, 1111, 1112. Here, as in FIG. 5, the translation engine is programmatically informed that the subject areas for these paragraphs are “TeamSports”, “Business”, and “Bowling”, respectively.

Use of the META tag is an appropriate choice since the subject area information may be considered a type of meta data for the structured document, and the syntax of the META tag allows it to be extendable (i.e., by choosing a value for the “name” attribute).

A drawback of using a document-wide subject area is that, in some cases, a particular subject area applies only to certain sections of a document. For example, a news document could contain multiple stories, as mentioned earlier. One story could be about labor relations, while another story is about baseball and yet another is about bowling. Using a document-wide subject area does not specify the subject area that should be applied to each story at a granular enough level in cases such as this. Thus, the document creator will preferably choose to use multiple embedded subject area tags or tag attributes for this content, using one of the techniques illustrated in FIG. 5, 6, or 11. This allows the subject area to be specified for each story (or, more generally, for each section or other area of content), even though they are all contained in the same document.

Turning now to a discussion of XML documents, the syntax of XML is readily extensible, and thus XML documents lend themselves to introduction of new tags or tag attributes to handle subject areas as disclosed herein. FIG. 12 shows an example syntax that may be used, whereby a new tag “<sa>” is specified, and the subject area itself is then specified as the content of this tag. FIG. 13 provides an alternative syntax, where the subject area is specified as the value of the “name” attribute. FIG. 14 shows an XML document 1400, having content that is identical to FIG. 1 except that it has now been marked up with subject area tags, according to the present invention. In this example, tag pair 1410, 1411 delimits content that pertains to sports, and thus the subject area tag specifies “sports” as the value of its “name” attribute. Within this sports-related text, there is a discussion of labor-relations information. Therefore, an embedded tag pair 1420, 1421 delimits this content, identifying “laborRelations” as the value of its “name” attribute.

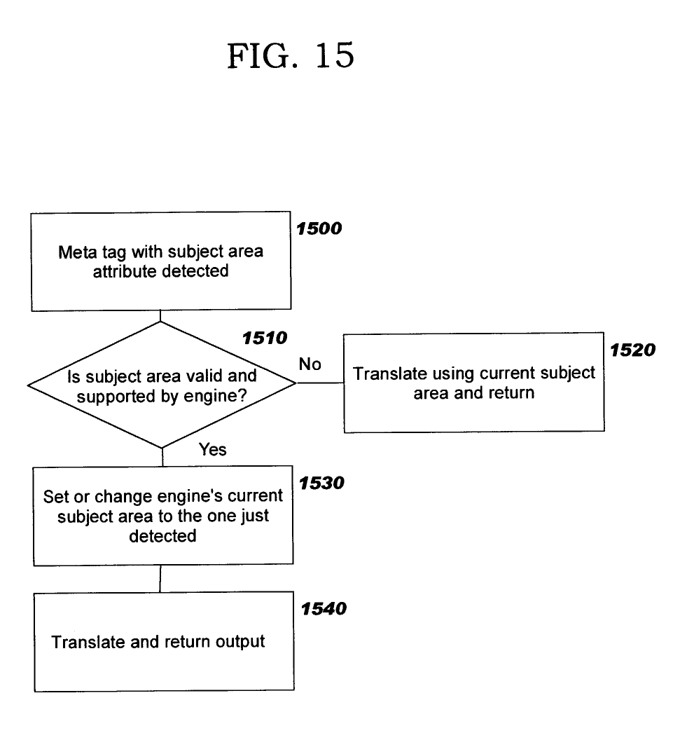

FIG. 15 provides a flowchart illustrating logic that may be used when implementing techniques disclosed herein. This logic may be incorporated within a structured document parser. Alternatively, this logic may be provided separately, for example as a pre-processor or post-processor to be used along with a structured document parser. The logic of FIG. 15 assumes that a callable routine is used.

Upon detecting a subject area tag or attribute (referred to in FIG. 15 as a meta tag with a subject area attribute, for purposes of illustration but not of limitation), as indicated at Block 1500, a test is made (Block 1510) as to whether the specified subject area is valid and supported by the current translation engine. If not, then control transfers to Block 1520, where the content will be translated using the current subject area (or a default subject area, if there is no identified subject area currently active). This translated content is then returned to the invoking logic.

When the test at Block 1510 has a positive result, then processing continues at Block 1530, where the translation engine's current subject area is set or changed to the subject area just detected. The content is then translated (Block 1540) and returned to the invoking logic. (Note that after translating content in Blocks 1520 and 1540, the translated content may be written into the original document in place of the original content, or a new copy of the document being translated may be created, with the translated content then written into this new copy.)

As has been demonstrated, the present invention provides advantageous techniques for enabling machine translation to operate more reliably and more efficiently, providing translated content that more accurately represents the original content. While preferred embodiments have been described with reference to tags/attributes embedded within textual content and translating textual elements, it should be noted that the techniques disclosed herein may also be adapted for use with non-textual documents (for example, by including logic such as that depicted in FIG. 15 in a processor that performs speech-to-text conversion and translation).

U.S. Pat. No. 6,363,337, “Translation of data according to a template”, teaches use of a template to facilitate machine translation. The subject area determines the structure of the data in the template, which holds data in a fixed format. The present invention does not use a template-driven approach and does not incur the overhead of entering data into a template.

U.S. Pat. No. 6,446,036, “System and method for enhancing document translatability”, teaches use of an “aggregate filter” that has a plurality of sections, each section having at least one atomic filter. Each section of the aggregate filter performs a specific process or processes on a document in a predetermined order, and the processed document is then translated. The present invention, on the other hand, does not use filters and does not require a series of processes or a predetermined order of processing.

U.S. Pat. No. 5,548,508, “Machine translation apparatus for translating document with tag”, teaches use of embedded tags along with a definition file that associates the tags to supplementary translation information. The tags are replaced with the supplementary information within the document. This document, including the supplementary information, is then translated. The present invention does not require an extra definition file, supplementary information for each tag, or preprocessing a document with supplementary information.

U.S. Patent Application Publication 2001/0027460A1, “Document processing apparatus and document processing method”, pertains to storing documents with multiple translations within the document, and using tags to display the right translation in relation to the viewer's language preference. The present invention, on the other hand, does not store translations within a document.

U.S. Patent Application Publication 2002/0161569A1, “Machine translation system, method and program”, discloses techniques for assisting a user in finding the meaning of an untranslated word in a translated text. A link is set to the untranslated word, with the target of this link set to the results of an Internet search for that word. The present invention does not use links to search results, and is not directed toward resolving untranslated words within a translated text.

U.S. Pat. No. 6,208,956, “Method and system for translating documents using different translation resources for different portions of the documents”, discloses use of separate data structures for each of the different sections (i.e., portions) of a document. These data structures store information to assist in a translation. A dictionary or rules may be automatically created, by either having a known translation that can be used to train the system or by having a user manually translate a document for use in training the system. The present invention does not train translation systems, and does not build dictionaries or rules.

These U.S. Patents and Patent Application Publications do not teach subject area tags, as disclosed herein.

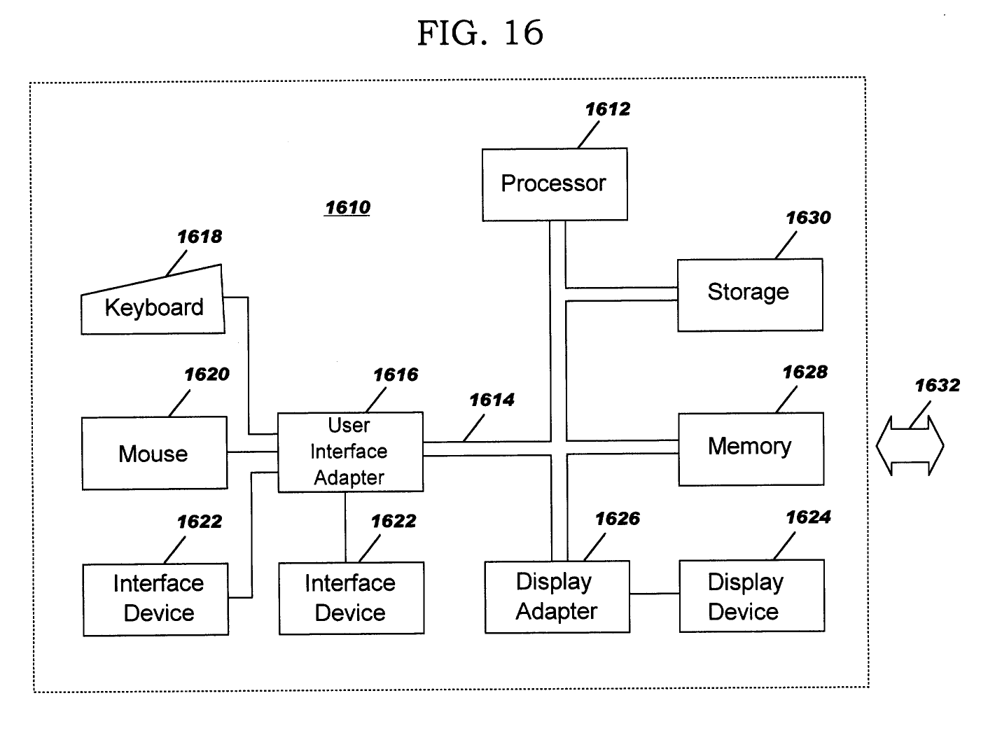

Referring now to FIG. 16, a representative computer hardware environment in which the present invention may be practiced is illustrated. For example, techniques of preferred embodiments may operate in a representative single user computer workstation 1610, such as a personal computer, which typically includes a number of related peripheral devices. The workstation 1610 includes a microprocessor 1612 and a bus 1614 employed to connect and enable communication between the microprocessor 1612 and the components of the workstation 1610 in accordance with known techniques. The workstation 1610 typically includes a user interface adapter 1616, which connects the microprocessor 1612 via the bus 1614 to one or more interface devices, such as a keyboard 1618, mouse 1620, and/or other interface devices 1622, which can be any user interface device (such as a touch sensitive screen, digitized entry pad, etc.). The bus 1614 may also connect a display device 1624, such as an LCD screen or monitor, to the microprocessor 1612 via a display adapter 1626. The bus 1614 may also connect the microprocessor 1612 to memory 1628 and long-term storage 1630 (which can include a hard drive, diskette drive, tape drive, etc.).

The workstation 1610 may communicate with other computers or networks of computers, for example via a communications channel or modem 1632. Alternatively, the workstation 1610 may communicate using a wireless interface at 1632, such as a cellular digital packet data (“CDPD”) card. The workstation 1610 may be associated with such other computers in a local area network (“LAN”) or a wide area network (“WAN”), or the workstation 1610 can be a client in a client/server arrangement with another computer, etc. As yet another alternative, the workstation 1610 may operate as a stand-alone device, not communicating over a network. All of these configurations, as well as the appropriate communications hardware and software, are known in the art.

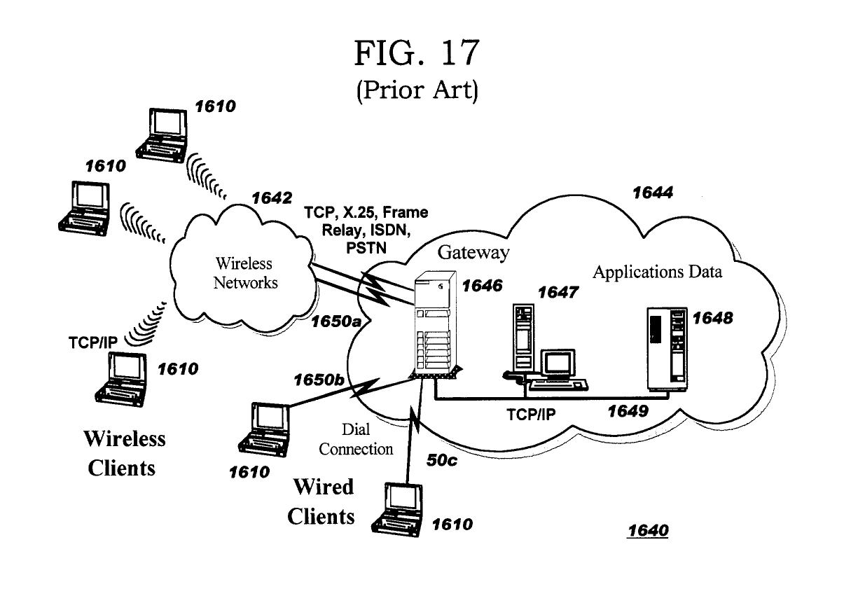

FIG. 17 illustrates a data processing network 1640 in which the present invention may be practiced. The data processing network 1640 may include a plurality of individual networks, such as wireless network 1642 and network 1644, each of which may include a plurality of individual workstations 1610. Additionally, as those skilled in the art will appreciate, one or more LANs may be included (not shown), where a LAN may comprise a plurality of intelligent workstations coupled to a host processor.

Still referring to FIG. 17, the networks 1642 and 1644 may also include mainframe computers or servers, such as a gateway computer 1646 or server 1647 (which may access a data repository 1648). Server 1647 may be (for example) an application server or an HTTP server. A gateway computer 1646 serves as a point of entry into each network 1644. The gateway 1646 may be preferably coupled to another network 1642 by means of a communications link 1650a. The gateway 1646 may also be directly coupled to one or more workstations 1610 using a communications link 1650b, 1650c. The gateway computer 1646 may be implemented utilizing an Enterprise Systems Architecture/370™ available from IBM®, an Enterprise Systems Architecture/390® computer, etc. Depending on the application, a midrange computer, such as an Application System/400® (also known as an AS/400® may be employed. (“Enterprise Systems Architecture/370” is a trademark of IBM®; “IBM”, “Enterprise Systems Architecture/390”, “Application System/400”, and “AS/400” are registered trademarks of IBM®.) The gateway computer 1646 and/or server 1647 may also be coupled 1649 to a storage device (such as data repository 1648). Furthermore, the gateway 1646 may be directly or indirectly coupled to one or more workstations 1610. The server 1647 may carry out machine translation using techniques disclosed herein.

Those skilled in the art will appreciate that the gateway computer 1646 may be located a great geographic distance from the network 1642, and similarly, the workstations 1610 may be located a substantial distance from the networks 1642 and 1644. For example, the network 1642 may be located in California, while the gateway 1646 may be located in Texas, and one or more of the workstations 1610 may be located in Florida. The workstations 1610 may connect to the wireless network 1642 using a networking protocol such as the Transmission Control Protocol/Internet Protocol (“TCP/IP”) over a number of alternative connection media, such as cellular phone, radio frequency networks, satellite networks, etc. The wireless network 1642 preferably connects to the gateway 1646 using a network connection 1650a such as TCP or User Datagram Protocol (“UDP”) over IP, X.25, Frame Relay, Integrated Services Digital Network (“ISDN”), Public Switched Telephone Network (“PSTN”), etc. The workstations 1610 may alternatively connect directly to the gateway 1646 using dial connections 1650b or 1650c. Furthermore, the wireless network 1642 and network 1644 may connect to one or more other networks (not shown), in an analogous manner to that depicted in FIG. 17.

Software programming code which embodies the present invention is typically accessed by the microprocessor 1612 of the server 1647 or workstation 1610 from long-term storage media 1630 of some type, such as a CD-ROM drive or hard drive. The software programming code may be embodied on any of a variety of known media for use with a data processing system, such as a diskette, hard drive, or CD-ROM. The code may be distributed on such media, or may be distributed from the memory or storage of one computer system over a network of some type to other computer systems for use by such other systems. Alternatively, the programming code may be embodied in the memory 1628, and accessed by the microprocessor 1612 using the bus 1614. Techniques and methods for embodying software programming code in memory, on physical media, and/or distributing software code via networks are well known and will not be further discussed herein.

The computing environment in which the present invention may be used includes an Internet environment, an intranet environment, an extranet environment, or any other type of networking environment. For example, the programmatic translation carried out using tags/attributes as disclosed herein may be performed on a Web server, while preparing to serve content to requesters across a communications medium. The scope of the present invention also includes a disconnected (i.e., stand-alone) environment, whereby document content may be translated, with programmatic guidance as to subject area, by a device which is preparing translated content to be stored for subsequent use (including subsequent serving to a requester). It should also be noted that requesters of translated content are not necessarily end users, but may alternatively be other executing programs or software components. The devices on which an implementation of the present invention may operate include end-user workstations, mainframes or servers, or any other type of device having computing or processing capabilities that can perform the operations discussed herein (or their functional equivalents). Representative examples of these devices, and the distributed computing networks in which they may optionally be executing, have been described with reference to FIGS. 16 and 17.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-usable storage media (including, but not limited to, disk storage, CD-ROM, optical storage, and so forth) having computer-usable program code embodied therein.

The present invention has been described with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

While preferred embodiments of the present invention have been described, additional variations and modifications in those embodiments may occur to those skilled in the art once they learn of the basic inventive concepts. In particular, while preferred embodiments were discussed with reference to HTML and XML, the disclosed techniques may be used advantageously with other markup languages as well. Furthermore, the novel techniques of the present invention are not limited to use with the particular tags and/or attributes that have been discussed herein. Therefore, it is intended that the appended claims shall be construed to include both the preferred embodiments and all such variations and modifications as fall within the spirit and scope of the invention.

What is claimed is:

1. A method of improving machine translation by identifying topics in structured documents, comprising steps of:
identifying one or more topics of content in a structured document;
adding markup language syntax to the structured document, for each one of the identified topics, to specify each of the identified topics, wherein the added markup language syntax is usable by a machine translator to programmatically determine a context for use when programmatically translating the content;
programmatically locating the added markup language syntax in the structured document, by the machine translator, thereby determining the context to use for each of the one or more topics; and
programmatically translating the content, by the machine translator, using the determined context.

2. The method according to claim 1, wherein the added markup language syntax comprises a markup language tag that precedes content of each one of the identified topics.

3. The method according to claim 2, wherein each of the markup language tags specifies one of the identified topics as an attribute.

4. The method according to claim 2, wherein each of the markup language tags specifies one of the identified topics as a tag value.

5. The method according to claim 2, wherein the markup language tags are Extensible Markup Language (“XML”) tags.

6. The method according to claim 5, wherein each of the XML tags has a corresponding closing tag that follows the content of the identified topic.

7. The method according to claim 2, wherein the markup language tags are Hypertext Markup Language (“HTML”) tags that are defined for content topic identification.

8. The method according to claim 2, wherein the markup language tags are Hypertext Markup Language (“HTML”) META tags.

9. The method according to claim 1, wherein the added markup language syntax comprises a markup language tag attribute that is specified on a markup language tag that precedes the content on each of the topics.

10. The method according to claim 9, wherein a value of the markup language tag attribute specifies the identified topic.

11. The method according to claim 9, wherein the markup language tag attributes are attributes of Extensible Markup Language (“XML”) tags.

12. The method according to claim 9, wherein the markup language tag attributes are attributes of Hypertext Markup Language (“HTML”) tags.

13. The method according to claim 1, further comprising the step of using, by the machine translator, the added markup language syntax to programmatically determine the context of the content when programmatically translating the content.

14. The method according to claim 1, wherein the content to be translated by the machine translator is textual content.

15. A system for improving machine translation by identifying topics in structured documents, comprising:
means for identifying one or more topics of content in a structured document; and
means for adding markup language syntax to the structured document, for each one of the identified topics, to specify each of the identified topics, wherein the added markup language syntax is usable by a machine translator to programmatically determine a context for use when programmatically translating the content.

16. A computer program product for improving machine translation by identifying topics in structured documents, the computer program product embodied on one or more computer-readable media and comprising:
computer-readable program code means for identifying one or more topics of content in a structured document; and
computer-readable program code means for adding markup language syntax to the structured document, for each one of the identified topics, to specify each of the identified topics, wherein the added markup language syntax is usable by a machine translator to programmatically determine a context for use when programmatically translating the content.

17. A method of preparing structured document content for programmatic translation, comprising steps of:
identifying one or more topics of content in a structured document;
adding markup language syntax to the structured document, for each one of the identified topics, to specify each of the identified topics, wherein the added markup language syntax is usable by a machine translator to programmatically determine a context for use when programmatically translating the content; and
charging a fee for carrying out the identifying and adding steps.

18. A method of performing improved programmatic translation of structured document content, comprising steps of:
obtaining a structured document into which markup language syntax has been added to identify one or more topics of content in the structured document; and
programmatically translating the content, using the added markup language syntax to programmatically determine a context of each of the identified topics.

19. The method according to claim 18, further comprising the step of charging a fee for carrying out the programmatically translating step.
